(19) United States
(12) Patent Application Publication
(10) Pub. No.: US 2015/0170256 A1
(43) Pub. Date: Jun. 18, 2015

(54) Systems and Methods for Presenting Information Associated With a Three-Dimensional Location on a Two-Dimensional Display

(71) Applicant: aisle411, Inc., Saint Louis, MO (US)

(72) Inventors: Nathan Pettyjohn, St. Louis, MO (US); Ed Saunders, St. Louis, MO (US); Niarcas Jeffrey, Cincinnati, OH (US); Dante Cannarozzi, St. Louis, MO (US)

(21) Appl. No.: 14/575,432

(22) Filed: Dec. 18, 2014

Related U.S. Application Data
(63) Continuation-in-part of application No. 13/461,738, filed on May 1, 2012.
(60) Provisional application No. 62/012,882, filed on Jun. 16, 2014.
(60) Provisional application No. 62/017,066, filed on Jun. 25, 2014.

(51) Int. Cl. G06Q 30/06; G06F 3/01; G06Q 30/02; G06F 3/0484; G06F 3/0481; G06T 19/00; G06F 3/00

(52) U.S. Cl. CPC G06Q 30/0639; G06T 19/006; G06T 19/003; G06F 3/011; G06F 3/005; G06F 3/04842; G06F 3/04812; G06Q 30/0251

(57) ABSTRACT

Systems and methods for creating an augmented reality mobile device application and using such an application in a retail environment to display marketing messages to a user.

### CROSS REFERENCE TO RELATED APPLICATIONS

This application is a Continuation-In-Part of U.S. patent application Ser. No. 13/461,788, filed May 2, 2012, and currently pending, which is, in turn, a Continuation-In-Part of U.S. patent application Ser. No. 12/134,187, filed on Jun. 5, 2008, now abandoned. This application also claims benefit of U.S. Provisional Patent Application No. 62/012,882, filed Jun. 16, 2014, and also claims benefit of U.S. Provisional Patent Application No. 62/017,066, filed Jun. 25, 2014. The entire disclosure of the above applications are incorporated herein by reference.

### BACKGROUND

1. Field of the Invention

This disclosure is related to the field of indoor mapping and location, specifically to the use of augmented reality in computerized mapping and navigation of indoor retail locations.

2. Description of the Related Art

Despite the prevalence of on-line shopping solutions and the ability to conduct extensive product research in advance, the majority of retail purchasing decisions are made by consumers while standing in the aisles. Two major factors influencing the purchasing decision are the products the consumer can see at a given location in the store, and the products the consumer can easily find. When a consumer struggles to find a product, the consumer is much more likely to give up (and not purchase it at all) even if the item is available for sale and the consumer desires to purchase it. The consumer may instead try another location, resulting in abandoned carts and lost sales.

To improve the consumer retail experience, help consumers find desired products, improve the impact of messaging, and reduce walkouts, content should be delivered to the consumer while in the aisles, and at the point when customer needs or desires the messaging: the point of purchase decision. Thus, messaging is more effective if delivered when the consumer is looking at the product or product group which is the subject of the messaging. For example, informing the consumer of current discounts on carbonated beverages is far more effective if the consumer is already in the carbonated beverage aisle, rather than across the store in the dairy section, where the consumer may forget about the discount before making his or her way to the beverage aisle, or may not be able to easily navigate to the location.

Stores have attempted to do this through the use of print advertising, such as paper signs collocated with particular products. This delivers messaging when the user is in the aisle browsing the products, but the consumer will only receive that messaging if the consumer actually goes to the specific aisle containing the collocated signage. If the consumer can't find the product, isn't aware of the product, or simply doesn't visit that aisle, the messaging is never received. Even if the consumer can find the product, the consumer may overlook the signage.

Another technique is paper circulars distributed at the entrance point to the store, which provide messaging about products before the consumer gets to the aisles. However, the messaging of paper circulars is most effective when the circular is first picked up and has the consumer's attention. After an initial scan, circulars are often stowed in purses, pockets, or carts and forgotten as the consumer wanders the aisles. Thus, paper circulars generally deliver messaging well prior to the point of purchase decision. Also, they do not provide customized navigational or location information to immediately direct the user to relevant products, reducing the effectiveness of the message.

Applications for smart phones and other mobile devices generally do little more than translate these deficiencies to digital format. For example, a user may be able to scan a QR code in the aisles to receive promotional information, but this requires the consumer to take the initiative, presenting the same problem as with paper signage, which requires the consumer to notice and read the sign. What is needed is the digital equivalent of an employee in the aisle directly distributing messaging about the products as the consumer is browsing them.

This in turn requires computer software and hardware systems capable of determining which products the consumer is likely browsing with a high degree of accuracy and precision. Doing so is difficult. In the first instance, delivering relevant messaging about a product when the user is making a purchasing decision about that product requires very accurate location detection. This is because the messaging should be delivered when the user is in the appropriate aisle and considering the product or product group that is the subject of the messaging. If a determination of the location is off by even as little as a meter, the consumer might be provided messaging for products located on the opposite side of the aisle. Moreover, particularly in densely-arranged retail locations such as grocery stores, one meter may be the difference between providing messaging about products the consumer is considering buying, or irrelevant products that happen to be stocked nearby.

This is made more complicated by the fact that existing consumer location detection systems generally experience accuracy degradation when used indoors. While GPS-enabled devices can accurately locate a GPS receiver to within a few meters in ideal circumstances, GPS is a satellite-based system and thus susceptible to a wide variety of interference sources, including naturally-occurring astronomical and terrestrial weather phenomena, tall buildings or trees, certain building materials, and radio emissions in adjacent frequency bands. Thus, GPS-based location systems tend to experience degraded accuracy in urban environments and, particularly, indoors.

Wireless network (“wi-fi”) signals can also be used, generally by taking a plurality of measurements of received signal strength, or RSS, and triangulating the location of the mobile device. However, wi-fi triangulation is vulnerable to signal fluctuations, lack of sufficient sample size, and sources of signal interference such as intervening shelving. Thus, despite the relatively short range of wi-fi access points, wi-fi triangulation can be inaccurate by a substantial margin in the context of consumer retail behavior, where messaging is preferably delivered to the user in real-time based upon the consumer's location in the store, and which products or types of products are displayed or sold at that location.

Another problem is that the user must get to the location. As indicated, paper signage and/or circulars are deficient, and finding an employee to direct the user to the proper shelf can be difficult. This can frustrate the shopper. Even where maps identifying key products are available, not all users are adept at using overhead maps. For example, younger users, and those with developmental delays or disabilities, may not be able to fully appreciate the spatial relationship between an indication in an indoor mapping application as to where the user is located, and an indication as to where the user is trying to go, and the route to get there. For example, where a two-dimensional map displays the user's location, and the user's destination, a young child may not be able to determine from the map which direction to walk in order to reach the destination.

Likewise, those with poor vision may not be able to discern a route displayed on a paper map or mobile device screen. Further, overhead-perspective indoor maps lack granularity. Retail shelving is typically stacked vertically, meaning that, from the perspective of an overhead map, there likely will be multiple products with substantially similar x-y coordinates, but different z-coordinates. But, because the overhead map is displayed in only two dimensions, the location of all products near a given x-y coordinate are clustered around the same point. This can make finding specific products difficult, and makes it more difficult to provide additional information to the user, such as detailed product information, advertising and marketing copy, and discount and coupon offers.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is a method for generating augmented reality area data comprising: providing an augmented reality data gathering device having a plurality of cameras, a plurality of orientation and movement sensors, and a non-volatile computer-readable storage medium; providing vendor data comprising: a vendor data coordinate system; merchandizing fixture data comprising a plurality of merchandizing fixture data sets, each one of the merchandizing fixture data sets having fixture locational coordinates and/or dimensions for a merchandizing fixture in a retail store, the fixture locational coordinates being coordinates in the vendor data coordinate system; a plurality of product data sets, each one of the product data sets having product data about a product and product locational coordinates corresponding to the location of the product on at least one of the merchandizing fixtures in the retail store, the product locational coordinates being coordinates in the vendor data coordinate system; generating in the non-volatile computer-readable storage medium a three-dimensional model of the interior configuration of the retail store, the three-dimensional model comprising: an internal coordinate system; an origin point in the internal coordinate system, the origin point corresponding to a location in the retail store; an internal camera, the internal camera having a default internal location at the origin point in the three-dimensional model and a default orientation in the three-dimensional model; for each one of the merchandizing fixture data sets in the merchandizing fixture data, translating the fixture locational coordinate for the merchandizing fixture from the vendor data coordinate system to the internal coordinate system of the three-dimensional model and generating in the generated three-dimensional model an opaque collidable object having a volume defined by the translated coordinates; placing the augmented reality data gathering device at the location in the retail store corresponding to the origin point and orienting the augmented reality data gathering device such that the orientation of the augmented reality data gathering device relative to the retail location corresponds to the default orientation of the internal camera in the three-dimensional model; moving the augmented reality data gathering device through the retail location; moving the internal camera within the three-dimensional model in real-time with the movement of the augmented reality data gathering device; during the movement of the augmented reality data gathering device, determining a location of the augmented reality data gathering device in the retail location and the plurality of cameras capturing a plurality of image datasets about the retail location at the determined location of the augmented reality data gathering device and the plurality of orientation sensors capturing orientation data about the augmented reality data gathering device at the determined location; storing in the memory area data comprising: at least one captured image dataset; at least one captured orientation dataset; and the detected location of the augmented reality data gathering device in the retail location when the at least one captured image dataset and at least one captured orientation dataset were captured.

In an embodiment, the fixture locational coordinates and/or dimensions comprise x-coordinates and y-coordinates for the location of a merchandizing fixture in the retail store.

In another embodiment, the fixture locational coordinates and/or dimensions further comprise a z-coordinate for the height of a merchandizing fixture in the retail store.

In another embodiment, the at least one stored captured image dataset comprises at least in part data about a visual element of the retail location.

In further embodiment, the visual element is selected from the group consisting of: an edge, a corner, a merchandizing fixture, furniture, flooring, ceiling, lighting, signage, a door, a doorway, a window, and a wall.

In another embodiment, determining a location of the augmented reality data gathering device in the retail location comprises determining the location of internal camera in the three-dimensional model, the location of the internal camera being at least a two-dimensional coordinate in the internal coordinate system of the three-dimensional model.

In another embodiment, the plurality of orientation sensors capturing orientation data about the augmented reality data gathering device at the determined location comprises determining the direction the internal camera is facing in the three-dimensional model.

Also described herein, among other things, is a method for providing messages to a consumer comprising: providing a mobile computing device comprising: a non-transitory computer-readable medium having thereon an augmented reality software application, the application having access to an augmented reality area description for a retail environment, the area description comprising a plurality of image datasets, each one of the image datasets having a corresponding coordinate in the retail environment, and the application having access to a plurality of messages, each one of the messages having a corresponding coordinate in the retail environment; a display operable by the application; and an imaging device operable by the application; in a retail environment, the application causing the imaging device to capture in real-time image data about the retail environment and the application causing the display to display in real-time the captured image data as images; locating in the area description at least one image dataset in the plurality of image datasets, the at least one image dataset corresponding to the image data about the retail environment captured in real-time by the imaging device; selecting one or more messages from the plurality of messages, the one or more messages being selected based upon the proximity of the determined location of the computing device to the selected message's corresponding coordinate in the retail environment; displaying on the display at least one of the selected one or more messages.

In an embodiment, at least one of the selected one or more messages is a marketing message.

In another embodiment, the plurality of messages is stored on the memory.

In another embodiment, the augmented reality area description is accessible over a telecommunications network.

In another embodiment, the plurality of messages is accessible over a telecommunications network.

In another embodiment, the application has access to a previously generated three-dimensional virtual model of the retail environment, the three-dimensional virtual model having an internal coordinate system and an internal camera; the corresponding coordinates in the retail environment for the plurality of image datasets are coordinates in the internal coordinate system; the corresponding coordinates in the retail environment for the plurality of messages are coordinates in the internal coordinate system; moving the internal camera within the three-dimensional model in real-time with the movement of the mobile computing device; the selecting step comprises calculating, in the internal coordinate system, the distance between the locational coordinates for the internal camera and the corresponding coordinate of each message and select a message for display if the calculated distance is within a pre-defined trigger threshold.

In another embodiment, the message is a coupon.

In another embodiment, the message is a user interface element selectable by a user to redeem the coupon.

In another embodiment, the user selects the element by tapping the displayed message.

In another embodiment, the message is an indication of a product category.

In another embodiment, the product category is selected from the group consisting of: gluten-free; heart-healthy; vegetarian; vegan; low-sodium; low-sugar; fair trade; organic; lactose-free; and local.

In another embodiment, the method further comprises: the mobile computing device comprising an orientation sensor; in the retail environment, the application causing the imaging device to generate in real-time orientation data about the orientation of the mobile computing device when the real-time image data is capture; the locating step further comprising locating in the area description at least one image dataset in the plurality of image datasets, the at least one image dataset having orientation data corresponding to the orientation of the generated real-time orientation data of the mobile computing device.

### BRIEF DESCRIPTION OF THE DRAWINGS

FIG. 1 depicts a flow chart of an embodiment of systems and methods for transmitting relevant messaging to a consumer at the time of purchase decision.

FIGS. 2A and 2B depict a flow chart of an embodiment of a system and method for importing retailer data.

FIG. 3 depicts a flow chart of an embodiment of a system and method for generating map files.

FIG. 4 depicts an embodiment of a system and method for presenting product and navigation information to a consumer.

FIGS. 5A and 5B depict a schematic diagram of an embodiment of a microlocation advertising system and method.

FIG. 6 depicts a schematic diagram of an embodiment of a microlocation advertising system and method using area learning.

FIGS. 7A and 7B depict an embodiment of a system and method for providing messaging to a user in a retail location through an augmented reality application when the user is physically proximate to the product to which the messaging pertains.

FIG. 8 depicts an embodiment of a system and method for generating augmented reality data for a retail environment, and in particular to the use of opaque collidable objects to implementing clipping of non-visible augmented reality elements.

FIG. 9 depicts a system and method for generating augmented reality data.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Because of these and other problems in the art, described herein, among other things, are systems and methods for delivering messaging to a mobile device in real-time based at least in part upon the detected location of the mobile device within a building or retail location. While the systems and methods described herein are generally in reference to an indoor retail space, the systems and methods may be used in any indoor location, whether or not retail in nature, as well as in non-indoor retail spaces, such as farmer's markets and flea markets. Also described herein, among other things, are systems and methods for aligning a positioning hardware location with retailer store map data. The systems and methods may display or cause to be displayed to a consumer an indication of the consumer's approximate current location in a retail location (generally, a retail store). Also described herein, among other things, are systems and methods for providing microlocation advertisements and messaging based upon a mobile device's current location. The systems and methods are generally implemented through an application on a mobile device carried by the consumer while in the retail location. The mobile device may be, but is not limited to, a smart phone, tablet PC, e-reader, or any other type of mobile device capable of executing the described functions. Generally speaking, the mobile device is network-enabled and communicating with a server system providing services over a telecommunication network.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g. “a remote host”), or may, in verb form, refer to a server providing a service over a network (“hosts a website”), or an access point for a service over a network.

Throughout this disclosure, the term “real time” generally refers to software performance and/or response time within operational deadlines that are effectively generally cotemporaneous with a reference event in the ordinary user perception of the passage of time for a particular operational context. Those of ordinary skill in the art understand that “real time” does not necessarily mean a system performs or responds immediately or instantaneously. For example, those having ordinary skill in the art understand that, where the operational context is a graphical user interface, “real time” normally implies a response time of about one second of actual time for at least some manner of response from the system, with milliseconds or microseconds being preferable. However, those having ordinary skill in the art also understand that, under other operational contexts, a system operating in “real time” may exhibit delays longer than one second, such as where network operations are involved which may include multiple devices and/or additional processing on a particular device or between devices, or multiple point-to-point round-trips for data exchange among devices. Those of ordinary skill in the art will further understand the distinction between “real time” performance by a computer system as compared to “real time” performance by a human or plurality of humans. Performance of certain methods or functions in real-time may be impossible for a human, but possible for a computer. Even where a human or plurality of humans could eventually produce the same or similar output as a computerized system, the amount of time required would render the output worthless or irrelevant because the time required is longer than how long a consumer of the output would wait for the output, or because the number and/or complexity of the calculations, the commercial value of the output would be exceeded by the cost of producing it.

Throughout this disclosure, the term “beacon” generally refers to short-range wireless transmitters communicating with nearby devices using a wireless communications protocol. Such transmitters generally use short-wavelength protocols, such as the IEEE 802.15 family of protocols or commercial successors thereto. However, in certain embodiments, a beacon may include devices using other wireless protocols, such as the IEEE 802.11 protocols or commercial successors thereto. Examples of such devices include Bluetooth transmitters and Bluetooth low energy (“BLE”) transmitters, including but not necessarily limited to a Motorola® MPact™ device and/or an Apple® iBeacon® device. It will be appreciated by one of ordinary skill in the art that this term, as used herein, is not limited to BLE devices, but rather may include all functionally similar wireless transmitters.

Throughout this disclosure, specific commercial or branded products may be described or identified as illustrative or exemplary embodiments of particular technologies. By way of example and not limitation, MySQL™ is known in the art to be an implementation of a database. It will be understood by one of ordinary skill in the art that such products inherently or implicitly disclose the broader category of products of which they are representative. By way of example and not limitation, MySQL™ further discloses any database implementation, such as but not limited to, Oracle®, PostgreSQL™, and other database systems, whether or not tabular or SQL-based, such as NoSQL.

Throughout this disclosure, the term “image” generally refers to a data record or representation of visually perceptible information. It will be understood by one of ordinary skill in the art that this includes, but is not limited to, two-dimensional still images and photographs, three-dimensional pictures, holograms, and video.

The definitions provided herein should not be understood as limiting, but rather as examples of what certain terms used herein may mean to a person having ordinary skill in the applicable art. A person of ordinary skill in the art may interpret these terms as inherently encompassing and disclosing additional and further meaning not expressly set forth herein.

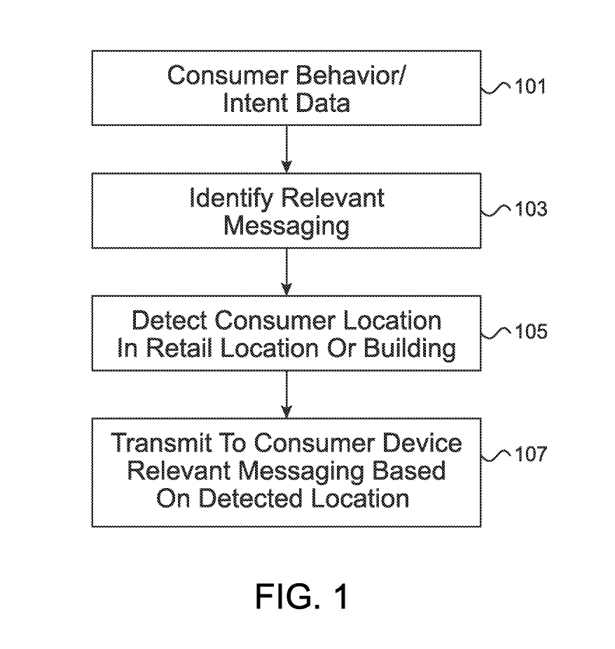

FIG. 1 depicts an embodiment of the systems and methods at a high level of abstraction. In the depicted embodiment, consumer behavior and/or intent data (101) is collected and used to identify relevant messaging (103) for the consumer associated with the consumer behavior data (101). The consumer's location in a retail location is detected (105) and, when the consumer's mobile device is detected in a particular location in the store for which there is relevant messaging, the relevant messaging is transmitted to the consumer's device (107). The systems and methods are generally implemented, from the consumer experience perspective, at least in part through a mobile device application.

In an embodiment, consumer behavior and/or intent data (101) is used to identify relevant messaging for a consumer. This consumer data may be provided directly by a consumer, such as by inputting a shopping list or recipe into a mobile device application. The consumer behavior data may also or alternatively comprise consumer behavior analytics or metrics now known or in the future developed in the art, which may be gathered or determined independently. By way of example and not limitation, such data may comprise: prior searches performed by the consumer; locations or stops by the consumer prior to arriving at the retail location; locations or stops by the consumer within the retail location during prior visits; locations or stops by the consumer within the retail location during the current visit; stop/browse time and locations by the consumer within the retail location; pathing by the consumer within the retail location; occurrence and duration of telephone calls by the consumer; other applications used by the consumer while in the retail location or prior to arriving at the store (e.g., comparison shopping with web retail sites such as Amazon®); date and time of the visit.

This data (101) may be used to identify relevant messaging for the consumer (103). For example, if the consumer is in the large appliance section of a home improvement or consumer electronics store and is searching on-line retailers for free shipping options using a mobile device, the consumer behavior data (101) may indicate that the consumer is comparison shopping shipping costs for an on-line retailer with delivery costs for the retail location. The relevant messaging selected (103) and transmitted (107) to this consumer may be a coupon for free delivery, installation, and/or set-up for any large appliance purchased that day while in the store, thus offering the consumer an incentive to purchase while at the retail outlet rather than order on-line (and costing the retail store a sale). This improves the ability of brick-and-mortar stores to remain commercially competitive with on-line retailers who don't have the overhead of physical locations.

Also by way of example and not limitation, the consumer behavior/intent data (101) may comprise that the consumer searched an on-line retailer for large-screen televisions within a certain amount of time prior to arriving at a consumer electronics retail store. When the consumer is detected (105) at the television section of the store, the consumer behavior/intent data (101) may be used to select relevant messaging (103) pertaining to large-screen televisions, and transmit (107) such messaging to the consumer's mobile device. This messaging may be, for example, manufacturer's discounts offered on televisions for sale at the store, up-sell opportunities, extended warranties, delivery and set-up specials, or special financing.

Extending this illustrative example further, if the date is just prior to the beginning of a particular sports league season, the relevant messaging (103) may be special discounts on cable or satellite television services including premium sports packages, such as NFL Sunday Ticket®. The selected messaging (103) may be refined even further using other consumer behavior/intent data (101). For example, if the consumer's web visit/search history or public interest information (e.g., a Facebook page) indicates an interest in a particular sports team, the selected messaging (103) to be transmitted (107) when the consumer is detected (105) in the television section may remind the consumer that if the consumer spends a certain minimum amount on a television today, the consumer will receive one free year of a premium sports package allowing the consumer to watch all of the games played by the consumer's favorite team.

In an alternative illustrative example, the selected messaging (103) may be transmitted (107) when the consumer is first detected (105) entering the store, informing the consumer not only that there is a special on premium sports packages, but also providing the consumer with a topological map of the retail location layout, the map showing a representation or indication of the consumer's current location within the retail location, the location of the television section, and directions to that section. Thus, the systems and methods may provide not only commercial messaging, but also navigational instructions to increase shopping efficiency. These instructions are generally determined and/or provided using retail mapping data, as described elsewhere herein.

This is particularly helpful for consumers who are new to the particular retail location and not be familiar with its layout. This also simplifies internal restructuring. A common obstacle to reorganizing retail products within a store is not only the physical labor of moving the products, but the resulting confusion and uncertainty that results, as loyal customers become frustrated when products can no longer be found in their usual locations. Messaging (103) may be transmitted (107) notifying the consumer, upon first entering the store (105), that the layout has changed, and encouraging the consumer to use the mobile device application to locate favorite products. The location of products within the retail location is mapped and stored as data. Prior versions of the retail geo-mapping data for a particular location can be maintained and consulted for comparison purposes, and cross-referenced with consumer behavior/intent data (101) to identify key products that may have moved. For example, if a particular consumer has a habit of visiting the wine aisle, and the wine has moved, when the consumer is detected (105) at the old location of the wine aisle, the mobile device application can transmit (107) to the consumer messaging that the wine has been moved to another location and, again, provide a topological map of the retail location showing the consumer's current location, the new location of the wine, and navigational instructions between the two points.

Generally, location is determined using one or more beacons placed at strategically selected locations within a retail location. One or more of the placed beacons detects the presence and/or location of a mobile device (105), generally based at least in part on communications between a beacon and the mobile device. Generally speaking, received signal strength, or RSS, is used to approximate the distance from a beacon to the mobile device, and thus to the consumer carrying the mobile device.

In one exemplary embodiment, a single beacon may be used. For example, due to the short range of a beacon, the mere fact that a consumer device has been detected or can communicate with the beacon at all may be sufficient to identify relevant messaging, such as where a consumer first enters a retail location and the consumer's mobile device can communicate with a beacon placed near the entrance. In a further embodiment, the signal strength between the device and beacon may further be examined to approximate the user's distance from the beacon, and that signal strength and/or approximated distance may be used to identify relevant messaging. In an alternative embodiment, a plurality of beacons may also be used to determine the approximate location of the consumer device, such as through triangulation techniques known in the art. Beacons may be used alone or in combination with other detection systems, including but not necessarily limited to wi-fi signals. The use of beacons improves the accuracy of location detection because the beacons are short-range transmitters placed near products, which experience less interference from intervening materials, and can provide highly accurate location data in real-time or near real-time.

To select relevant messaging (103), a particular location in the store may be associated with specific products or product categories, such as by use of a product and/or search taxonomy associated with the identity of a beacon physically proximate to the particular location in the store where the specific products are located. Thus, targeted messaging may be transmitted (107) to a mobile device, the messaging being selected (103) based at least in part on the products, products categories, or taxonomies associated with the particular beacon (or beacons) to which the mobile device is detected (105) as being physically proximate.

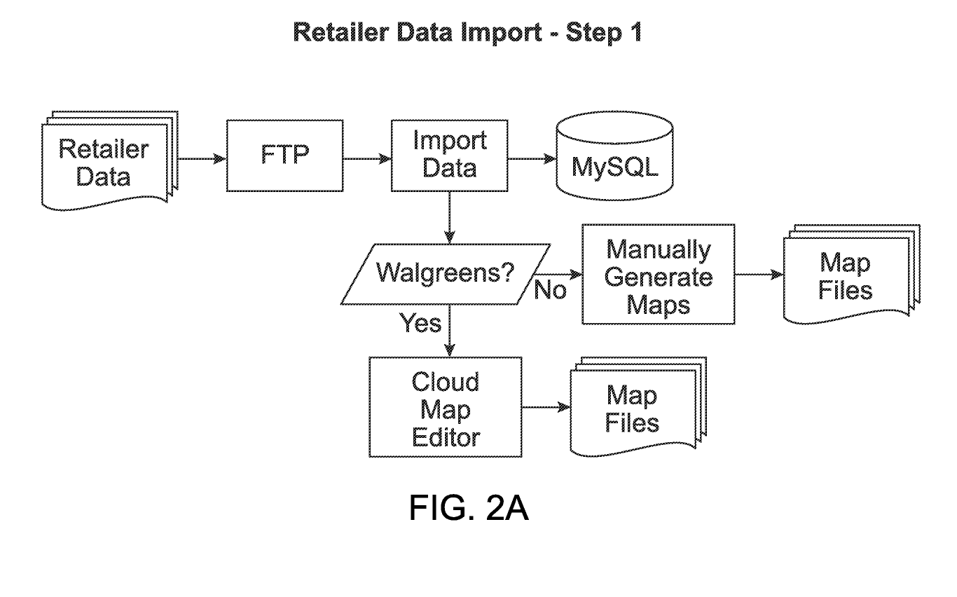

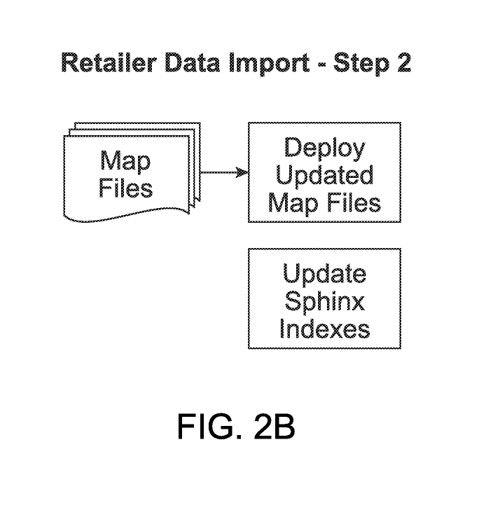

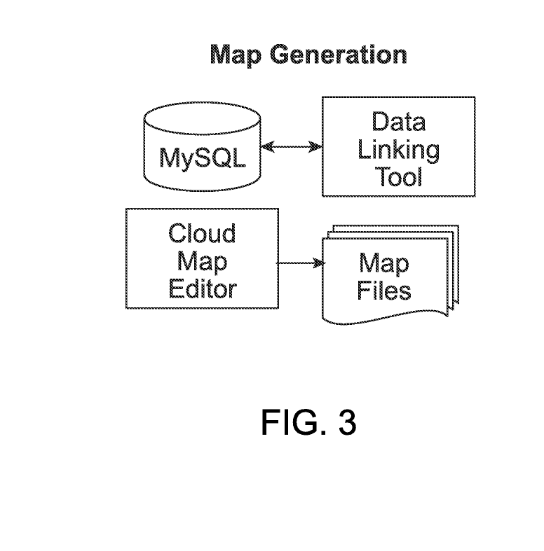

In one exemplary embodiment, the beacons and/or mobile device generally are in communication over a network with a remote computer server system having an associated database containing retailer data, map data, and product data, product search data, and/or taxonomy data. The particular arrangement and content of these data sets will necessarily vary not only from embodiment to embodiment, but also from retailer to retailer. By way of example and not limitation, one such arrangement is described in U.S. Utility patent application No. 13/943,646, filed Jul. 16, 2013, the entire disclosure of which is incorporated herein by reference. Also by way of example and not limitation, another such arrangement is described in U.S. Utility patent application Ser. No. 13/461,738, filed May 1, 2012, the entire disclosure of which is incorporated herein by reference. This data is generally imported and formatted in advance of a consumer using the systems and methods, including by the systems and methods depicted in FIGS. 2A, 2B, and 3.

In the described exemplary embodiment, when a beacon identifies or detects a nearby consumer device in the retail location, the beacon transmits an identifier, indication, or identification of the consumer or consumer device to the retail computer system, along with an identifier, indication, or identification of the beacon which detected or identified the consumer. The consumer device and/or beacon may be identified using any reasonably unique identifier known or in the future developed in the art, including but not necessarily limited to physical or hardware addresses, network addresses transport addresses, serial number, and/or phone number or identification number. These and other identifiers may be determinable from ordinary network communications or by querying the device. In an alternative embodiment, the server receives the identification information for the mobile device and/or the beacon from the mobile device itself. In a still further embodiment, the server may receive the identification from another third party device, such as a local server or controller.

Generally, the retail computer system uses the unique identifiers to identify relevant messaging for the location by matching or cross-referencing consumer behavior/intent data with product, product category, and/or other taxonomy data associated with the beacon. Map data may be used, at least in part, to determine consumer behavior/intent, may be included in the messaging, neither, or both. By way of example and not limitation, if consumer behavior/intent data (101) indicates that messaging pertaining to large electronic appliances is relevant to this consumer, the server data need only reflect that beacons with certain identification numbers are associated with large electronic appliances (that is, the beacon with a particular identification number has been placed in the large appliance section of the retail location, and retail data about large appliances is associated with that beacon number). When the consumer associated with the consumer behavior/intent data (101) is detected (105) near such beacon, the server can identify that the consumer is near large appliances (without the server having to first determine where large appliances are physically located in the retail location) and select messaging (103) relevant to large appliances for transmission (107) to the consumer's mobile device.

Alternatively, and as discussed elsewhere herein in an illustrative example, a particular messaging campaign may not merely transmit (107) content when the consumer is detected (107) at a particular location in the retail location, but may transmit (107) navigational and/or map data to the consumer, which is used to provide in a mobile application a visual representation of the location of the consumer in the retail location, and navigational data to direct the consumer to a particular location. In such an embodiment, map data may be used to transmit (107) messaging, in that the consumer will be provided a topological map with navigational instructions.

Also alternatively, map data may be used to select messaging (103). By way of example and not limitation, where the consumer is detected (105) lingering in the candy section and the date is February 13^{th}, the consumer's location may be used at least in part to select messaging (103) about greeting cards or wine. Thus, the messaging content may not only convey discounts or promotions on products the consumer is already interested in, but may suggest additional relevant products.

Also described herein, among other things, are systems and methods for determining and/or displaying a mobile device's position on a map by layering a visual map on top of a topological map and aligning the coordinate systems. In an embodiment, the system uses a previously captured sparse map, sometimes also referred to as an area description, comprising a plurality of physical attributes of the mapped space, and overlays a logical map comprising retail store data. Generally, the systems and methods display one or more objects selected from the logical map as virtual reality objects, the positions of such displayed objects being obtained from retail data. Thus, an “augmented reality” interface to the retail location can be displayed to a consumer. The process of generating or creating a sparse map (or area description) is also sometimes known as area learning.

In an embodiment, microlocation content and/or messaging is displayed to the consumer. This may be based upon the consumer device's current position and its multi-axis orientation. In a further embodiment, loyalty rewards are displayed in specific locations, generally specified by the retailer. The consumer may also search for products or objects and the system will display the locations of, and/or a route to, the results. The system can show a branded experience at a specific location and orientation by delivering offers, collecting rewards, and providing product information.

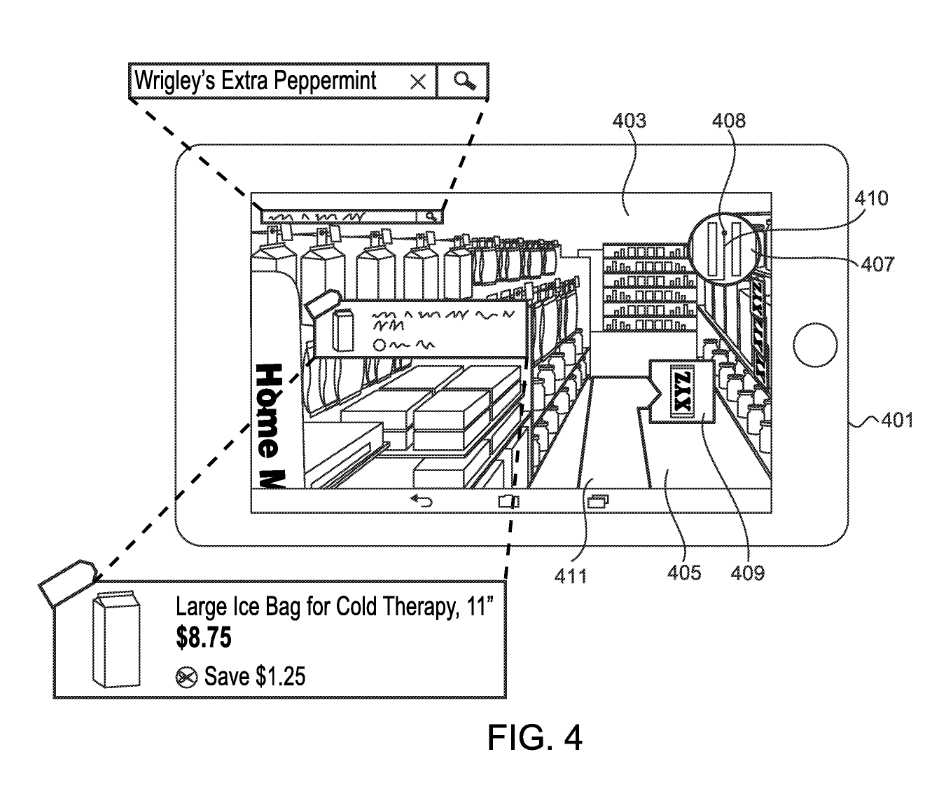

An exemplary embodiment, implemented as a mobile device application, is depicted in FIG. 4. In the depicted embodiment, a mobile device (401) having a display (403), displays a real-time image of a retail location (405), said image comprising a generally faithful presentation of the current state of the retail location. This image is generally produced at least in part using an imaging device built into the mobile device, such as a digital camera. The image is overlaid with various components to create an augmented reality experience. By way of example and not limitation, a topological map (407) of the retail location is displayed. In the depicted embodiment, the topological map (407) is a topological map of the retail location depicted (405) in the display (403), and comprises an indication of the location (408) of the consumer in the retail location and an indication of navigational instructions (410) to locate a certain product (409) in the retail location. In another embodiment, the topological map (407) may further comprise an indication of the location of the product in the retail location (not depicted).

In the depicted embodiment, the display further comprises an image of a specific product sought (409), displayed in a callout and located in the augmented reality image in the approximate location of the product on the shelf. The display further comprises overlaid navigational instructions (411) to the location of the product (409). In a still further embodiment, the display comprises messaging (413) in a callout. The messaging may be displayed in connection with the physical location of the product to which the messaging pertains. One of ordinary skill in the art will appreciate that, in an augmented reality application, the location of the overlaid components on the display (403) will move, resize, and/or disappear from the display, and new overlaid components may appear, resize, and/or move on the display, as the location and orientation of the device (and thus, the display) changes in response to consumer behavior or movement. This is because at least some of the overlaid components are associated with a set of at least two-dimensional, and preferably three-dimensional, coordinates within the retail location. In an augmented reality application, the appearance, location, and size of augmented reality components is generally determined and presented such that the augmented reality components are displayed, if at all, in region of the mobile device currently displaying the associated coordinates.

The depicted embodiment comprises the use of the Google® Project Tango™ platform, but other functionally equivalent or similar platforms may also, or alternatively, be used in an embodiment.

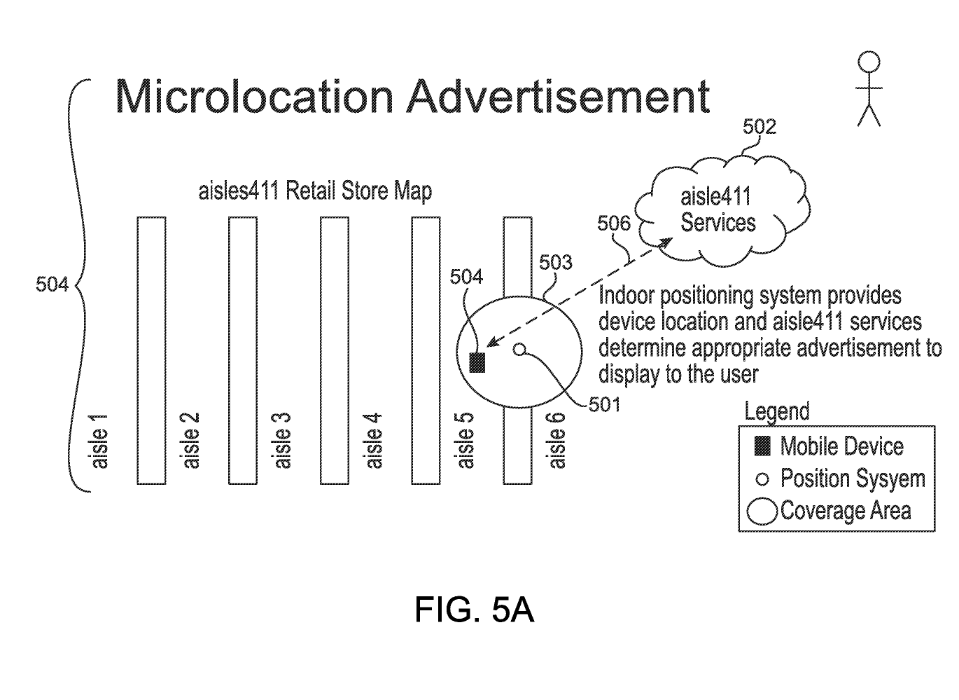

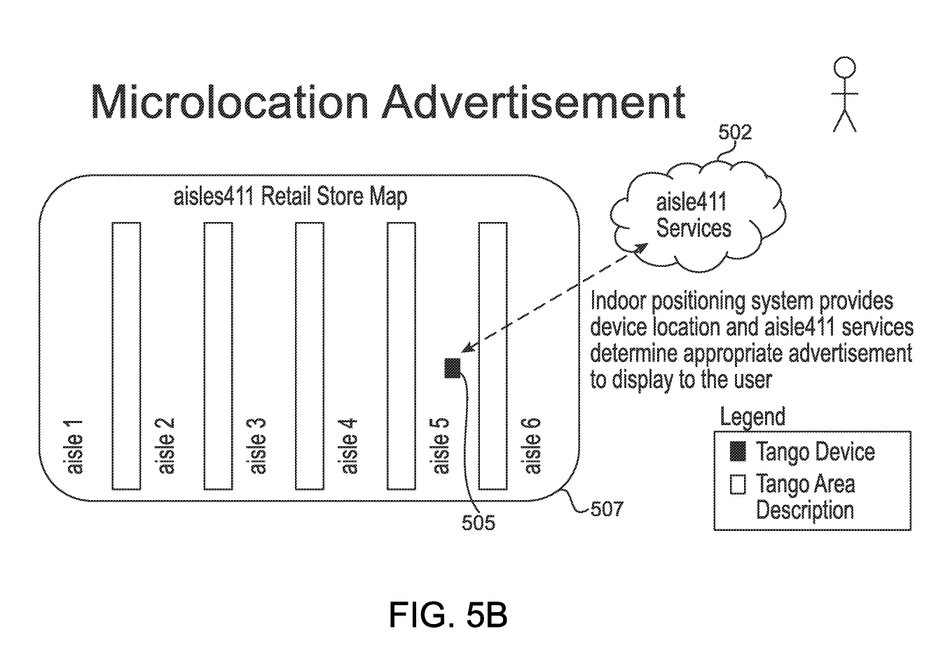

FIGS. 5A-5B depict an embodiment of a microlocation advertising system and method. In the depicted embodiment, a positioning system (501) is used to determine the location of a mobile device (505) within a retail location (504). The positioning system (501) generally comprises one or more detection nodes placed in the retail location (504), each of which has a range, or coverage area (503). A mobile device (505) within a coverage area (503) can communicate with the positioning system (501), such as by detecting, or being detected by, a node in the system. Because the location of a node in the retail location (504) is known, the location of the mobile device (505) can be approximated with precision and accuracy.

This location information can be transmitted (506), generally wirelessly over a network, to an advertising delivery platform or system (502), which uses the location data for the device to identify relevant advertising. This identification is generally based at least in part on data about products located in the retail location (504), and about the whereabouts of such products in the retail location (504). This identification may also be based at least in part on data about the location of the mobile device (505), including but not necessarily limited to an identification, identifier, or indication of the particular node in the positioning system (501) which detected the location of the device. The advertising platform (502) is generally implemented at least in part as a computer server as described elsewhere herein.

The retail location (504) may be represented in data by a sparse map or area description (507), such as that implemented via the Google® Project Tango™ platform. Generally, the area description (507) data is coordinated or aligned to retail map data retained or stored by the advertising platform (502). This, in combination with data about mobile device (505) location, orientation, and/or motion, facilitates or improves the mobile device's (505) ability to present the augmented reality described herein, such as in FIG. 4, accurately with respect to the location, orientation, and/or motion of the mobile device (505) within the retail location (504).

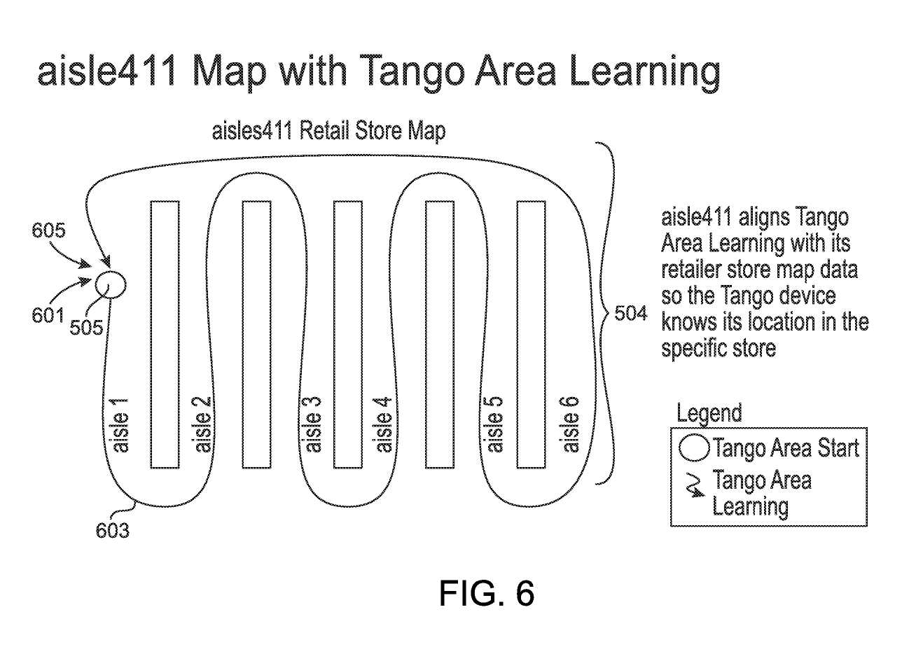

In an embodiment, such as the embodiment depicted in FIG. 6, area learning may be used. Area learning generally comprises programmatically interpreting new information based at least in part on previously gathered information. By way of example and not limitation, a mobile device begins at a starting point (601) within a retail location (504) and is carried or moved along an area learning path (603) to an end point (605). The starting point (601) and end point (605) may be the same general location in a retail location (504), or a different location. The mobile device (505) generally generates location imaging data about the retail location (504), generally by using an image capture and/or recording mechanism or means, such as a mobile device (505) camera. The location imaging data may be stored, recorded, and/or generated in a digital library of image data about the retail space (504). In an embodiment, the library may have been developed, at least in part, using data about the retail location (504) generated by the mobile device (505) and/or by other devices, such as devices which previously imaged same retail location (504).

When a mobile device (505), which may be a different mobile device from a device which captured location image data comprising the library, is in the retail space (504), imaging hardware in the mobile device (505) may be used to capture additional location image data in realtime as the user moves through the retail location (504). This data may be compared to location imaging data in the library to determine the approximate location, orientation, and/or motion of the mobile device (505) in the retail location (504), and/or to improve, augment, supplement, or refine such a determination. This may be done, for example and without limitation, through use of drift correction and/or relocalization. In an embodiment, the area learning data, including but not necessarily limited to location image data, may be aligned or coordinated with retail store map data to improve the accuracy of a determination of mobile device (505) location, orientation, and/or motion within a retail location (504). In a further embodiment, this alignment or coordinate may also be used to present an augmented reality interface on a mobile device (505) display, such as by displaying to a user information, including but not limited to advertising, overlaying realtime imaging data about the retail location (504), such realtime imaging data being captured by the mobile device (505) while the user is in the retail location (504).

In an embodiment, the determination of mobile device (505) location within the retail location (504) is accurate to within one meter. In a further embodiment, the determination of mobile device (505) location within the retail location (504) is accurate to within 0.5 meters. In a still further embodiment, the determination of mobile device (505) location within the retail location (504) is accurate to within 0.25 meters. In a further embodiment, the determination of mobile device (505) location within the retail location (504) is accurate to within ten centimeters. In a further embodiment, the determination of mobile device (505) location within the retail location (504) is accurate to within 5 centimeters. In a further embodiment, the determination of mobile device (505) location within the retail location (504) is accurate to within more than 2 centimeters. In a further embodiment, the determination of mobile device (505) location within the retail location (504) is accurate to within 1 centimeter.

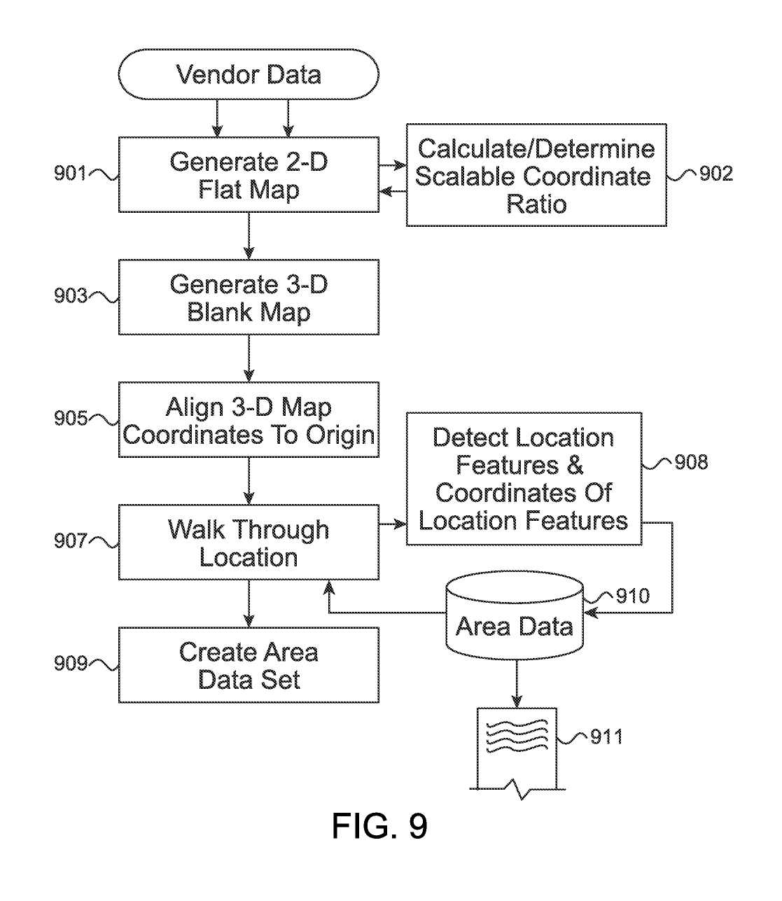

FIG. 9 depicts an embodiment of a system and method for generating area data for use in an augmented reality application. At a high level, the depicted system comprises generating a two-dimensional flat map from vendor data (901), generating a three-dimensional map from the two-dimensional map (903), aligning an augmented reality data gathering device with respect to an origin (905), performing an augmented reality data gathering in a location (907), and generating an area data set from the data gathered (909). These elements and steps are described in more detail herein. It should be noted that while in the depicted embodiment a two-dimensional flat map is generated, vendor data may include a third dimension. Thus, in alternative embodiments, the two-dimensional flat map step may be omitted or modified, and/or a three-dimensional map may be generated directly from vendor data, such as by using the third dimension.

Generating a two-dimensional map (901) generally comprises receiving vendor data and generating a two-dimensional overhead map of a retail space based at least in part on the vendor data. Vendor data typically comprises, by way of example and not limitation, a plurality of product location data sets, and/or a plurality of venue or location data sets (such as but not necessarily limited to merchandizing fixture datasets).

A product location data set typically comprises product identification information, such as but not limited to product identification, manufacturer and/or supplier and/or distributor, or SKU. A product location data set also generally comprises information about the location of the product in a retail space, such as a location on shelving or gondolas. Product location data typically comprises an x- and y-coordinate identification with respect to an origin point in the retail space. For example, a vendor may store product location as an offset, in inches, of each product from the center of the main entrance to the store. Although examples used herein generally use inches as a measuring unit, any unit may be used in an embodiment. Also, as described elsewhere herein, product location data may further comprise a z-coordinate.

A venue or location data set typically comprises information about the physical layout of a retail location, such as coordinates and/or dimensions for the physical shape and size of the retail space, and/or coordinates and/or dimensions for retail structures and/or major store features, such as but not limited to: product display structures and merchandising fixtures, including without limitation shelving, gondolas, endcaps, kiosks, bins, and point-of-purchase/point-of-sale displays; store features such but not limited to entrances, exits, customer service locations, departments, restrooms, and other store features.

In an embodiment, each coordinate/dimension in the vendor data is converted to an internal coordinate system (902). This coordinate system may be a fixed coordinate system using the same or different units as the coordinate system used in the vendor data, or may be a scalable coordinate system. By way of example and not limitation, the internal coordinate system may have a range from 0 to 1 and each of the x- and y-coordinates in the vendor data is translated to the 0-1 range of the internal scalable coordinate system. There are several techniques for doing this. In the preferred embodiment, the vendor data is examined to determine the maximum value for an axis, some padding is added to that value, and the resulting range is then converted to the 0-1 scale and each individual location data set value for the axis is interpolated onto the 0-1 scale. Finding the maximum is usually trivial and can be done through any technique known in the art, such as but not limited to an iterative algorithm that stores in memory the highest value detected and thus far and replaces it if a higher value is detected in a subsequent iteration, or sorting the dimensions and identifying the end-points.

The padding is an additional amount of range on the axis added to the maximum value detected. The padding may be added for a number of reasons, including but not limited to providing symmetry in the unused whitespace on either side of the range, which may cause the resulting generated map to appear more aesthetically pleasing, or to provide for the possibility of future items that will be mapped and which have a higher maximum. The padding amount may be determined or selected using a number of techniques. One such technique is to use a fixed amount; for example, adding 60 inches to the maximum. A second technique is to pad by an amount equal to the minimum; for example, if the minimum x-axis value detected is 39 inches, add 39 inches of padding to the maximum. A third technique is to pad by a predetermined percentage; for example, if the predetermined percentage is ten percent (10%) and the maximum found is 330 inches, adding 33 inches of padding to the maximum. A fourth technique is to pad by a percentage or amount, where the percentage or amount is based upon a statistical measure of the values for an axis, such as the variance or standard deviation.

In an alternative embodiment, padding may not be added. For example, the maximum range of the space to be mapping may be known, which may eliminate the need to add padding. By way of example and not limitation, the maximums may be provided by the vendor (such as but not limited to in the vendor data) or may have previously been determined, provided, or estimated through other means.

Interpolating the vendor coordinates onto the scale is typically a matter of applying simple mathematical operations. For example, where the scalable coordinate system uses 0 through 1, the corresponding coordinate value on that scale is equal to each location data set coordinate's percentage of the maximum plus the padding. For example, if the maximum x-coordinate (plus padding) is 363 inches, and a given location data set in vendor data has a coordinate of 74 inches, the percentage is calculated by dividing 363 into 74, and arriving at a (rounded) scalable coordinate value of 0.2038568.

The precision of the scalable coordinate figure is important because the scale can be multiplied by a pixel resolution to generate differently-sized maps, and imprecision in the scalable coordinate value can result in error. By way of example and not limitation, if the above example (74 inches on a map having a max+padding x-axis of 363 inches) were scaled to a display with a pixel width of 1800 pixels, the x-coordinate for the location of the item on the map is equal to 1800*0.2038567, or 367 pixels (rounded). However, if a less precise rounded coordinate value is used, such as 0.20, the pixel location calculation produces 360, which is imprecise by a factor seven pixels. Given that this illustrative embodiment has a pixel/inch ratio of about 5 (1800 pixels/363 inches), a margin of error of seven pixels translates into a margin of error of 35 inches, or almost three feet. Again, in tightly-packed shelving, this degree of error can mislead the consumer about where products are located, and greater precision is required.

The two-dimensional map is generated from the coordinate data at a given pixel size or screen resolution. In an embodiment, the two-dimensional map is generated at a sufficient resolution that the generated map, when displayed on an anticipated end-user device, may be displayed in its entirety in its native resolution without the need for panning, scaling, zooming, or resizing. In an alternative embodiment, the image is generated at a much higher resolution and scaled down for display, allowing the user to manipulate the image in memory without significant pixilation. Alternatively, for a given venue, a plurality of two-dimensional maps may be generated for use with various devices. This will typically (but not always), require at least some padding or other scaling, because the aspect ratio of the map is not ordinarily the same as the aspect ratio of the display device.

The two-dimensional map typically depicts an overhead model of the major store features, such as walls, entranceways, and merchandising fixtures. In the preferred embodiment, the depicted features are generally to scale, but in an alternative embodiment, they may be distorted. This may be due, for example, to: technological limitations on pixel density and/or resolution of the display device; unusual venue shape, dimensions, or ratios; or, aesthetic considerations. A two-dimensional map may be stored in a proprietary image format or a generally known image format. Alternatively, the two-dimensional map may be stored as a serialized object in a plaintext format, including but not necessarily limited to as a serialized byte array, serialized object, or encoded binary data (e.g., the product of a binary-to-text encoding scheme, such as but not limited to MIME, Base64, or other translations using a non-decimal radix).

Generally speaking, the orientation of the map image (901) is such that when the image is displayed on a device, the back of the store (generally defined as the wall of the store opposite the entrance) is at the “top” of the screen (i.e., the top of the map image) as viewed on a typical display device. This orientation is preferred for ease-of-use purposes. When a user first enters a store and loads the map, the user is generally facing the back of the store. By orienting the map so that the back of the store is at the top of the map, when a user views the map on a user device after first entering the store, the orientation of the map likely corresponds to the layout of the store from the user's perspective. That is, the back wall of the store, which is ahead of the user, is at the top of the map, the left wall is to the user's left, the right wall is to the user's right, and the entrance (at the bottom of the map) is behind the user. This type of orienteering of two-dimensional images to represent three-dimensional structures is generally intuitive to most users due to its frequent use in other applications, such as road signs used in highway navigation.

Generating a three-dimensional map from the two-dimensional map (603) generally comprises building or generating a three-dimensional model in memory based on the two-dimensional map and/or data associated therewith. Generally speaking, the 3-D model is wireframe formed by extending the x-y coordinates of the two-dimensional map vertically along the z-axis. Where vendor map data includes elevation data, such as but not limited to shelving height dimensions, ceiling heights, or other data usable to identify the distance of a z-axis translation for one or more features of the map data, the wireframe is formed by translating two-a dimensional structure along the positive z-axis and connecting vertices. The three-dimensional map is effective a “virtual reality” copy of the store layout in memory. It will be appreciated that the particular label or identity of the axes may vary from embodiment to embodiment.

In an embodiment, the 3-D map is generated using a 3-D graphics development platform. Video game platforms are particularly useful for this function, as they provide for “camera” positioning within the 3-D model and handle geometric operations in three dimensions to facilitate navigation within the 3-D model. By way of example and not limitation, the Unity® game development engine can be used to generate and navigate through the 3-D model.

Augmented reality data is gathered, generally during a walk-through (907) of the location. In an embodiment, this is done using specialized measuring and sensing equipment. The data gathering process generally comprises physically moving (907) the data gathering device through the store with the specialized sensing equipment enabled and gathering data. As the device is moved (907) through the store, location information is also gathered and/or generated (908), and the gathered/generated data from the specialized sensing equipment is associated with various locations in the store and stored in an area data structure (910). This is described in further detail elsewhere herein.

In an embodiment, the equipment comprises one or more image capturing devices, such as a camera. In the preferred embodiment, the specialized equipment comprises one or more of: a camera or other general-purpose imaging device; a wide-angle camera and/or lens; a black and white camera and/or lens; a grayscale camera and/or lens; a high-resolution camera and/or lens; a general-purpose accelerometer; a high-accuracy accelerometer such as, but not limited to, an inertial sensor; and/or a depth sensor. This equipment may be deployed on a stock user device, such as a tablet computer, smart phone, or wearable computer, or a special-purpose device. For sake of simplicity, regardless of the configuration, this device will be referred to herein as the data gathering device.

Before the data gathering device begins gathering data, the device must be located and oriented (905) in the physical venue consistently with the location and orientation of the “camera” in the 3-D model. By way of example and not limitation, consider an illustrative example using Unity® as the 3-D modeling software. Unity® is a three-dimensional game development platform and, like most game development platforms, includes an internal “camera” to identify the perspective within the 3-D environment from which the rest of the 3-D environment is rendered. That is, to generate an image of a 3-D environment, a perspective location and orientation/direction must be known. Thus, Unity® includes an internal “camera” object having a location and facing direction, which is essentially a rotational angle around the z-axis. Unity® also includes an internal coordinate system, generally measured in meters. At initiation, the Unity® camera is located at the origin (0,0,0) and is facing due south (generally towards positive z-axis, though the particular orientation of the axes with respect to the camera may vary in an embodiment).

When the data gathering device is enabled for the walk-through (907), the data gathering device should be located (905) at the physical location in the store corresponding to the origin in the Unity® model of the store, and the device should be oriented (905) such that the user of the device is facing the front of the store (usually corresponding to “south” on a 3-D map, or “down/bottom” on a 2-D map, regardless of whether the actual cardinal direction of the front of the store is south of the origin). That is, when the user physically moves (907) the device towards the front of the store (“south” in Unity® or “down” on a 2-D map), the movement (907) of the user is consistent with the mapping layout.

In such an embodiment, this location/orientation exercise is important because the movement (907) of the data gathering device is an input used by the 3-D modeling software (e.g., Unity®) to move the internal “camera” in the 3-D modeling software. By way of example and not limitation, when the user of the data gathering device begins the data gathering exercise and physically moves (907) towards the front of the store, the movement (907) of the device in that direction is detected, and data indicative of movement is provided as input to the 3-D modeling software to indicate the movement of the internal camera within the 3-D modeling software within the 3-D model (that is, rather than a user sitting a desktop and manipulating a keyboard/mouse to indicate to the 3-D modeling software how the user wishes to move the internal camera through the model, the movement of the data gathering device itself provides that indication to the 3-D modeling software). Thus, if the user of the data gathering device walks ten feet forward in the physical location, the internal camera in the 3-D modeling software moves ten feet straight ahead of its current orientation within the 3-D model. Likewise, if the user of the data gathering device turns 90 degrees to the left, the internal camera in the 3-D modeling software is rotated 90 degrees to the left. This interaction may use an additional software layer.

As indicated, if the orientation (905) of the data gathering device in the store is not the same as the default orientation of the internal camera in the 3-D modeling software, the movement of the user will not be synchronized to the movement (907) of the internal camera in the 3-D model. By way of example and not limitation, if the user is facing the back of the store, but the default orientation of the 3-D modeling software internal camera is towards the front of the store, when the user walks forward 10 feet (towards the back of the store), the internal camera in the modeling software will also move forward 10 feet, but since its default orientation is towards the front of the store, this movement will not match that of the actual user.

Likewise, if the user does not begin the data gathering process at the location of the store corresponding to the default location of the internal camera (e.g., the origin), the data gathering will also be out of sync because the data gathered will be associated with an internal coordinate of the modeling software that does not correspond to the correct real-world location in the store. That is, if the internal coordinate origin for the 3-D modeling camera corresponds to an x-y coordinate in the store of 180 inches by 300 inches, but the user begins the data gathering process while standing at the store entrance which has coordinates of 90 inches by 0 inches, the data gathered will be (in the real world) data for the entranceway, but the data will be associated with the portion of the store corresponding to the origin point in the 3-D modeling software (e.g., the location of the store at 180 inches by 300 inches).

Some or all of the data gathered/generated (908) by the data gathering device may also be associated with the internal coordinate system of the 3-D modeling software. By way of example and not limitation, the Unity® software generally uses meters as the internal coordinate unit, with (0,0,0) being the origin. The internal coordinate system need not bear any relationship to any other coordinate system, but rather typically is used for internal structure, data modeling, and tracking. Thus, as data about the venue is gathered during the walk-through, the data may be associated with values in the internal coordinate system of the 3-D model corresponding to the location in the real-world store at which the data was detected. Note that it is contemplated that there may be three or more coordinate systems: a vendor-provided coordinate system, an internal coordinate system associated with the two-dimensional map (such as the scalable coordinate system described above), and an internal coordinate system associated with the 3-D model.

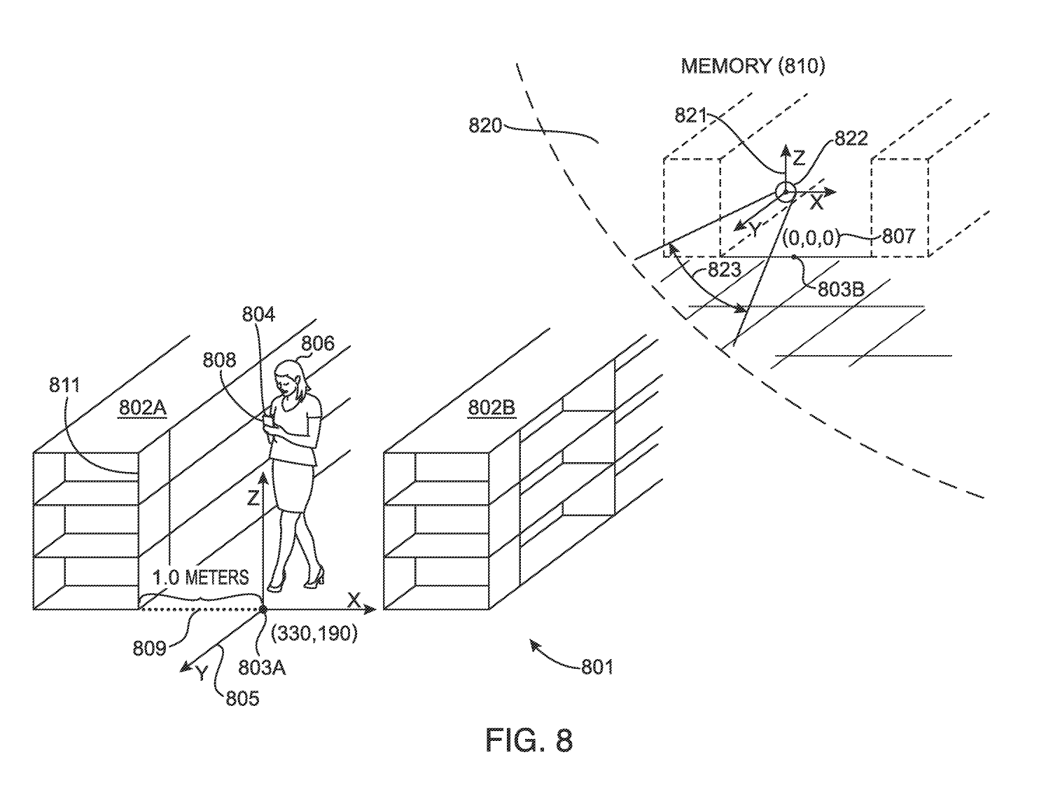

An exemplary embodiment is depicted in FIG. 8. In the depicted embodiment, a retail location (801) having merchandising fixtures (802) for storing products for sale is to be mapped using the systems and methods described herein. A 3-D model (820) of the location to be mapped exists in the memory or storage media (810) of the data gathering device (804). The 3-D model (820) includes an internal coordinate system (821) and an origin point (803B) for the internal camera (822). The depicted internal camera (822) is a software object which provides a reference point, or rendering perspective (823), for rendering the 3-D model (820), such as on a display (808).

In the depicted embodiment, the location of the origin (803B) in the internal coordinate system (821) has associated values (807), which are 0,0,0. The origin point (803B) also has a corresponding real-world location in the actual retail location (803A). The real-world origin point (803A) generally has a corresponding coordinate location in a second coordinate system (805), which second coordinate system (805) is generally separate and independent from the internal coordinate system (821) of the 3-D modeling system. By way of example and not limitation, the second coordinate system (805) may be the coordinate system used by a vendor in vendor data to identify the location of products within the retail location. Alternatively, the second coordinate system (805) may be an internal coordinate system for a mapping application, such the scalable coordinate system described above. In a still further embodiment, as described above, both of these second coordinate systems may exist within the system.

To gather data for the venue, the device (808) is positioned in the store (801) at the origin point (803A) and oriented to the same orientation as the internal camera (822). The user then moves the device (808) through the retail location (801) while capturing data using at least in part some of the specialized equipment described herein. It is preferred that the device (808) be moved the length of each aisle in both directions and along each side of each aisle. The sensors, cameras, and other detecting equipment capture data as the device (808) is moved, as well as location information recording the location of the device (808) when a dataset about the environment was detected or gathered. The gathered data about the environment generally is indicative of fixed features of the environment. By way of example and not limitation, such features may be floors, merchandizing fixtures (802A) and (802B), corners (811), lights, ceilings, signage, and other visual or structural elements of the location which do not generally change significantly in appearance, and are generally not substantially obscured. The gathered data is generally known as area description data, and is generally stored, such as in a database, file, set of files, data structure, or the like. The stored area data is generally referred to as a sparse map or area description.

As indicated, the area description (911) may also include location data associated with the gathered area data (910). This location data generally identifies a coordinate or other location identifying mechanism associated with a particular set or data about a particular location in the mapped area. By way of example and not limitation, in the depicted embodiment of FIG. 8, when the mapping is first commenced, the device (808) gathers data about the portion of the retail location (801) between the origin (803A) and store front because the device (808) is located at the origin (803A) and oriented towards the store front. Thus, the sensors and imaging equipment on the device (808) capture data about that section of the store (801), and the area data about that location is associated with location data about the location. For example, the area data may be associated with the internal coordinates (821) for the origin (803B). Alternatively, the location data about the location may use a coordinate location in a second or third coordinate system (805), either of which may be, for example, a vendor coordinate system or a scalable coordinate system such as the scalable coordinate system described herein.

As the device (808) is moved through the location (801), the movement is detected by the movement-sensing equipment on the camera, including but not necessarily limited to the accelerometer and/or inertia sensors. Such movement includes pan, tilt, rotation, and translation movement, and the amount of such movement can be approximated or determined with reasonably accuracy by the equipment. Data indicative of the amount, direction, and nature of such movement is used both to update the location of the internal camera (822) in the 3-D modeling system, and to identify a location to associate with area data.

By way of example and not limitation, in the depicted embodiment, if the device (808) is rotated 90 degrees to the right of the user, a shelf (802A) is located one meter (809) away. A depth sensor on the device (808) may detect fixed features of the shelf (802A), such as the corner (811), and the depth sensor on the device (808) may detect the approximate distance (809) to that feature (811). The corresponding location of that feature (811) in the internal coordinate system (821) is equal to the origin minus one meter on the depicted x-axis (821), and the area data gathered about the corner (811) is thus associated, on the internal coordinate system (821), with values (−1, 0, 0).

In an embodiment, other data may also be gathered/generated and associated. For example, the gathered data may indicate the corner (811) is approximately 1.5 meters tall (or that information may otherwise be known or determined), providing a z-axis range or coordinate for the top of the corner (811). The corner (811) may then be associated in the internal coordinate system (821) with a range of values, such as (−1,0,0) to (−1,0,1.5). During the walk-through (907), such area data, which may include associated locational coordinates, is detected (608) for a plurality of features or elements of the location (801). The resulting area data set (909) may be stored or exported to an area description (911), which may be a database, flat file, or any other structured data object, generally stored on media.

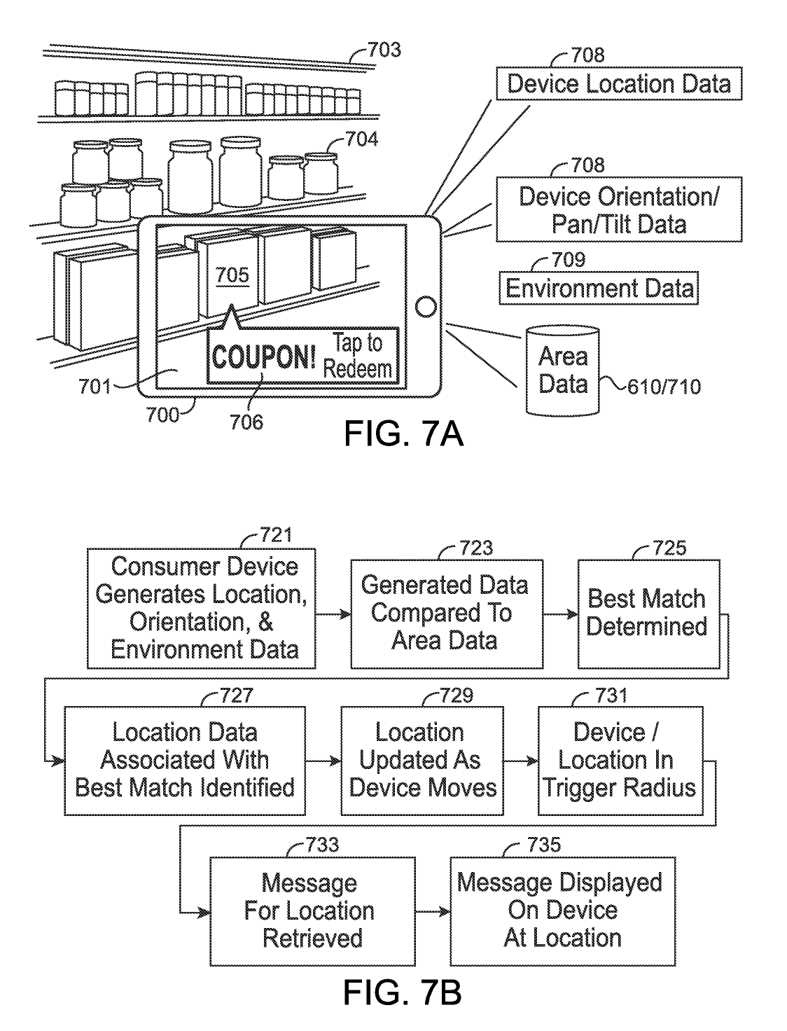

The resulting area description (911) is deployed to, or otherwise made available or transferred to, an end-user device, which device is used by an end-user in the location (801) in an augmented reality experience via an end-user application. An exemplary embodiment is depicted in FIG. 7. In the depicted embodiment, a retail location has a merchandizing fixture (703) with one of more products (704) disposed thereon. An end-user with an end-user device (700) having a computer-readable media with an augmented reality application thereon moves through the retail space, using the augmented reality software application to provide the augmented reality experience. The depicted device (700) comprises a display (701) and storage media and/or a memory which includes area data (710) for a retail location (801). The end-user device (700) is generally outfitted with an imaging device such as a camera, and sensors such as an accelerometer.

The augmented reality software application causes the camera and/or sensors to gather (721) and/or generate (721) environment data (709) in real-time about the retail location (801), and gather (721) and/or generate (721) device location and orientation data (708) in real-time. Generally, image data captured by the camera is displayed (705) in real-time on the display (701), similar to how a typical smart phone or digital camera operates when the user attempts to take an ordinary photograph and views the scene to be photographed through an LCD display. When the software application is launched on the device (700), the end-user device (700) gathers/generates image and orientation data (721) about the environment. This data is compared (723) to the area data in the area description, and a matching dataset, or one or more candidate matching datasets, in the area data is identified (725). This may be done, for example, using best fit algorithms, statistical comparison, and other techniques known in the art. When the match is identified (725), locational coordinates associated with the matching data are also identified (727) and used to determine the location of the user in the retail space. In an embodiment, additional techniques may be used to fine-tune or refine the determined location of the device, such as the beacon technologies described elsewhere herein. Once the location and orientation of the end-user device is determined (727), the internal camera location and orientation in the 3-D map in memory is set to the coordinate values for the device's location in the internal coordinate system of the 3-D map, and the camera orientation.

By way of example and not limitation, suppose a user enters a retail location, walks partway through the store, and then turns on the augmented reality application on his or her device (700). The camera on the device (700) generates image data and orientation data as the user pans the camera across the aisles. This image data and orientation data is compared to area data previously captured by the data gathering device, which area data is in the area description, along with associated location and orientation data for the data gathering device when it captured that area data. When a match is found, the locational coordinates associated with the matching area data, which are generally coordinates in the 3-D internal coordinate system, are used to set the location of the internal camera in the 3-D map. At this point, the user's location in the store has been determined and as the user pans the camera and moves about the store, just as with the data gathering device, the movement of the real-world camera (in both location and orientation) is an input to the movement of the internal camera in the 3-D model, and the virtual location of the user in the model is thus kept generally synchronized in real-time with the real-world location of the user in the store.

It should be noted that, for the end-user device, the 3-D model is maintained and the location of the internal camera is updated as the user moves through the retail location, but these steps are generally carried out in memory and may not necessarily be displayed or conveyed to the user. Generally, the user sees the graphical user interface elements of the augmented reality application, and the passed-through imaging data captured in real-time by the end-user device camera.

The 3-D model is used in the background for several purposes. First, the 3-D model of the store fixtures models the fixtures as opaque objects for clipping purposes, which may be rendered transparently (or as a transparent layer) within the augmented reality application to provide for three-dimensional clipping planes beyond which objects in memory are not rendered. This improves usability by not rendering objects in neighboring aisles or on the opposite side of an aisle. This is important because, as described later, information may be overlayed over the real-time camera image in the display (701), such as coupons and advertising, based on user proximity to the coupon. However, if the user turns laterally so that the camera is facing a shelf, items on the opposite side of the shelf having associated overlay data (described below) would ordinarily render. This would confuse users, who cannot see the far side of the shelf, and to whom it appears that messaging for the wrong products is being displayed. The technique described herein provides for an object that is visually transparent when rendered in the augmented reality application (and thus, does not obscure the shelves or other real-time imaging data in the application), but opaque for clipping purposes. By coordinating the rendering of this object such that it corresponds to where real-world images of shelving would appear, the object provides an unseen clipping plane for data that should not be displayed to the real-world user because the real-world user cannot see the relevant product.

Second, the 3-D model of the store fixtures provides for collision detection around store fixtures, which in turn facilitates pathing and routing algorithms for displaying user navigation instructions to specific features or products on the display.

In an embodiment, the augmented reality application may display a product and/or deal data and location layer, which will generally be referred to herein as the “product layer.” The augmented reality software application accesses, is provided with, or otherwise has available to it a data set indicative of locations in the store where the user may encounter products, categories of products, bargains, deals, coupons, special offers, discounts, and other marketing communications or messages. In an embodiment, this data is stored in the device memory and accessed, loaded, cached, memory mapped, received, or otherwise made available (733) to the application at runtime. In an alternative embodiment, this data is received (733) in real-time at runtime, such as through client-server communication with a server over a telecommunications network. This dataset generally comprises the same or similar data as the vendor data described elsewhere herein, or derived therefrom.

By way of example and not limitation, the dataset may comprise a list of products with associated internal coordinate locations in the 3-D modeling system. Alternatively, the dataset may comprise a list of products with associated vendor coordinate locations, or may comprise such product data with associated scalable internal coordinates. In such alternative embodiments, the locational coordinates are translated to the internal coordinate system of the 3-D modeling system at runtime, or in real-time as such data is received (733) (e.g., over a telecommunications network), according to the particular implementation and architecture of the system. This is generally done using coordinate system translation techniques known in the art.

The product/deal data location layer is generally created or loaded at runtime, and one or more products and/or deals are formed as objects in the 3-D model associated with particular coordinates in the internal coordinate system of the 3-D model. As the end-user moves through the retail space (721), the internal camera is also moved through the 3-D model of the location (729), and the coordinates of the internal camera are updated (729) to maintain synchronization between the location of the end-user device in the actual store, and the internal camera in the 3-D model of the store.

When the location of the internal camera in the 3-D model of the store is within a predefined radius of internal coordinate system coordinates associated with particular product data, a pre-set event trigger (731) causes certain information (706) and (735) pertaining to the product (705) to be displayed (735) on the end-user device (700) at a location on the end-user device (700) display (701) corresponding to the product location. Thus, from the user experience perspective, when the user pans the camera over certain products (705), the display (701) presents additional information (706) and (735) about the products (705). This information (706) and (735) may include messaging, such as marketing messages. Marketing messages include, without limitation: sales, deals, bargains, promotions, offers, discounts, coupons, incentives to purchase, or other such messaging. Alternatively, information (706) may be displayed (735) about products (705) based on a characteristic of the product (705). By way of example and not limitation, all gluten-free products may be highlighted, circled, or otherwise indicated in the display. Other characteristics may include product family, manufacturer, on-sale, discounted, age appropriateness, and/or clearance status.

In an embodiment, the displayed information (706) may include interactive GUI elements. By way of example and not limitation, where the associated product information is a coupon (706), the user may tap the pop-up message (706) in the display (701) to redeem the coupon. Other interactive features may also be supported, such as tapping products to include in a shopping list, a save-for-later list, or recipe builders. By way of example and not limitation, the user may be able to tap a particular product (705) on the display (701) and request a list of recipes using that product (705). In a still further embodiment, the user may be able to request the location of all other ingredients for the recipe, and get navigation directions to find those ingredients, as described elsewhere herein.

In an embodiment, users may search for products using a GUI, and may further request navigation or pathing information. As described above, because the aisles are modeled in the 3-D model as opaque objects with collision boxes, pathing and routing algorithms may be used to determine paths from the current location of the internal camera (i.e., corresponding to the current location of the user within the store) to the location of a particular product. These paths may then be overlayed on the real-time image captured by the camera and displayed on the display (701). By way of example and not limitation, a line may be rendered on the floor which the user can follow to reach the desired item. As the device is panned and moved, the display of the line on the screen is adjusted to synchronize its location and maintain the appearance of consistency with the displayed environment data. By way of example and not limitation, if the camera is panned slightly to the right, the location and appearance of the line on the display will generally change (moving slightly to the left) because the viewing angle of the line is different and the portion of the store displayed has changed. This in turn means that the orthogonal projection of the line on the display is adjusted to maintain the appearance of the line at a fixed location with respect to the real-time background image. Likewise, if the camera is panned up or down, the rendering of the line must also change to reflect that the line is being viewed at different angles, and thus its orthogonal projection unto the two-dimensional display changes to maintain the augmented reality appearance and experience. This may be done, for example, by modeling the floor in the 3-D model as an opaque object for clipping purposes, similar to the shelves, but rendering it as a transparent layer visually, and then drawing the path on the floor. This allows the 3-D modeling software to handle the geometric/trigonometric calculations required to render the line consistently, reducing development time.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A method for generating augmented reality area data comprising:
providing an augmented reality data gathering device having a plurality of cameras, a plurality of orientation and movement sensors, and a non-volatile computer-readable storage medium;
providing vendor data comprising:
a vendor data coordinate system;
merchandizing fixture data comprising a plurality of merchandizing fixture data sets, each one of said merchandizing fixture data sets having fixture locational coordinates and/or dimensions for a merchandizing fixture in a retail store, said fixture locational coordinates being coordinates in said vendor data coordinate system;
a plurality of product data sets, each one of said product data sets having product data about a product and product locational coordinates corresponding to the location of said product on at least one of said merchandizing fixtures in said retail store, said product locational coordinates being coordinates in said vendor data coordinate system;
generating in said non-volatile computer-readable storage medium a three-dimensional model of the interior configuration of said retail store, said three-dimensional model comprising:
an internal coordinate system;
an origin point in said internal coordinate system, said origin point corresponding to a location in said retail store;
an internal camera, said internal camera having a default internal location at said origin point in said three-dimensional model and a default orientation in said three-dimensional model;
for each one of said merchandizing fixture data sets in said merchandizing fixture data, translating said fixture locational coordinate for said merchandizing fixture from said vendor data coordinate system to said internal coordinate system of said three-dimensional model and generating in said generated three-dimensional model an opaque collidable object having a volume defined by said translated coordinates;
placing said augmented reality data gathering device at said location in said retail store corresponding to said origin point and orienting said augmented reality data gathering device such that the orientation of said augmented reality data gathering device relative to said retail location corresponds to said default orientation of said internal camera in said three-dimensional model;
moving said augmented reality data gathering device through said retail location;
moving said internal camera within said three-dimensional model in real-time with said movement of said augmented reality data gathering device;
during said movement of said augmented reality data gathering device, determining a location of said augmented reality data gathering device in said retail location and said plurality of cameras capturing a plurality of image datasets about said retail location at said determined location of said augmented reality data gathering device and said plurality of orientation sensors capturing orientation data about said augmented reality data gathering device at said determined location;
storing in said memory area data comprising:
at least one captured image dataset;
at least one captured orientation dataset; and
said detected location of said augmented reality data gathering device in said retail location when said at least one captured image dataset and at least one captured orientation dataset were captured.

2. The method of claim 1, wherein said fixture locational coordinates and/or dimensions comprise x-coordinates and y-coordinates for the location of a merchandizing fixture in said retail store.

3. The method of claim 2, wherein said fixture locational coordinates and/or dimensions further comprise a z-coordinate for the height of a merchandizing fixture in said retail store.

4. The method of claim 1, wherein said at least one stored captured image dataset comprises at least in part data about a visual element of said retail location.

5. The method of claim 4, wherein said visual element is selected from the group consisting of: an edge, a corner, a merchandizing fixture, furniture, flooring, ceiling, lighting, signage, a door, a doorway, a window, and a wall.

6. The method of claim 1, wherein said determining a location of said augmented reality data gathering device in said retail location comprises determining the location of internal camera in said three-dimensional model, said location of said internal camera being at least a two-dimensional coordinate in said internal coordinate system of said three-dimensional model.

7. The method of claim 1, wherein said plurality of orientation sensors capturing orientation data about said augmented reality data gathering device at said determined location comprises determining the direction said internal camera is facing in said three-dimensional model.

8. A method for providing messages to a consumer comprising:
providing a mobile computing device comprising:
a non-transitory computer-readable medium having thereon an augmented reality software application, said application having access to an augmented reality area description for a retail environment, said area description comprising a plurality of image datasets, each one of said image datasets having a corresponding coordinate in said retail environment, and said application having access to a plurality of messages, each one of said messages having a corresponding coordinate in said retail environment;
a display operable by said application; and
an imaging device operable by said application;
in a retail environment, said application causing said imaging device to capture in real-time image data about said retail environment and said application causing said display to display in real-time said captured image data as images;
locating in said area description at least one image dataset in said plurality of image datasets, said at least one image dataset corresponding to said image data about said retail environment captured in real-time by said imaging device;
selecting one or more messages from said plurality of messages, said one or more messages being selected based upon the proximity of said determined location of said computing device to said selected message's corresponding coordinate in said retail environment;
displaying on said display at least one of said selected one or more messages.

9. The method of claim 8, wherein at least one of said selected one or more messages is a marketing message.

10. The method of claim 8, wherein said plurality of messages is stored on said memory.

11. The method of claim 8, wherein said augmented reality area description is accessible over a telecommunications network.

12. The method of claim 8, wherein said plurality of messages is accessible over a telecommunications network.

13. The method of claim 8, further comprising:
wherein said application has access to a previously generated three-dimensional virtual model of said retail environment, said three-dimensional virtual model having an internal coordinate system and an internal camera;
wherein said corresponding coordinates in said retail environment for said plurality of image datasets are coordinates in said internal coordinate system;
wherein said corresponding coordinates in said retail environment for said plurality of messages are coordinates in said internal coordinate system;
moving said internal camera within said three-dimensional model in real-time with said movement of said mobile computing device;
wherein said selecting step comprises calculating, in the internal coordinate system, the distance between the locational coordinates for said internal camera and the corresponding coordinate of each message and select a message for display if said calculated distance is within a pre-defined trigger threshold.

14. The method of claim 8, wherein said message is a coupon.

15. The method of claim 14, wherein said message is a user interface element selectable by a user to redeem said coupon.

16. The method of claim 15, wherein the user selects the element by tapping the displayed message.

17. The method of claim 8, wherein said message is an indication of a product category.

18. The method of claim 17, wherein said product category is selected from the group consisting of: gluten-free; heart-healthy; vegetarian; vegan; low-sodium; low-sugar; fair trade; organic; lactose-free; and local.

19. The method of claim 8, further comprising:
said mobile computing device comprising an orientation sensor;
in said retail environment, said application causing said imaging device to generate in real-time orientation data about the orientation of said mobile computing device when said real-time image data is capture;
said locating step further comprising locating in said area description at least one image dataset in said plurality of image datasets, said at least one image dataset having orientation data corresponding to said orientation of said generated real-time orientation data of said mobile computing device.
